(19) United States
(12) Patent Application Publication
(10) Pub. No.: US 2007/0209532 A1
(43) Pub. Date: Sep. 13, 2007

(54) Yard waste tamper

(76) Inventor: Mark Noxon, Markham (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 11/373,128

(22) Filed: Mar. 13, 2006

(51) Int. Cl. B30B 15/06

(52) U.S. Cl. 100/295; 100/265

(57) ABSTRACT

A yard waste tamper apparatus comprises a conical body having a tamping end and a connecting end. The tamping end has a slightly convex face with protruding nipples spaced out over the face. The connecting end is integrated into the body and has an opening to a conical insertion channel having a larger diameter at the opening. The tamper apparatus is designed to accept a rake handle inserted into the opening and the tamper apparatus and is held on the rake handle by a pressure fit with the conical insertion channel. Thus, the waste tamper can fit on the end of various diameter rake handles because the diminishing diameter of the insertion channel facilitates a universal fit. Once attached to the rake, a user can use the tamper apparatus to compact leaves and light yard waste into a waste container.

### FIELD OF THE INVENTION

The present invention relates generally to tampers and compactors. This invention is a lightweight, universal fit attachment quickly and easily fitted to a yard rake handle to allow yard waste to be tamped down in a yard waste bag.

### BACKGROUND OF THE INVENTION

Many communities are now mandating the recycling of yard waste such as fallen leaves. Light yard waste such as leaves is collected, often by raking, and then put into plastic or increasingly, recyclable paper bags, for collection by local municipal authorities. Sometimes there is a fee per bag for collection of these filled bags. The bags have to be purchased by property occupiers. While plastic bags are significantly cheaper, and can be as much as 5 times less expensive than paper bags, plastic is not recyclable so increasingly a recyclable paper bag is specified.

The present invention allows a user to tamp leaves down into a bag, advantageously resulting in less bags being used. Such tamping eliminates the air spaces between leaves which exist when leaves are deposited into a bag. Consequently, a user needs fewer bags to package a given volume of yard waste. This minimizes the cost to a user of disposing of yard waste because fewer bags are required.

There are other compactor devices which have been created. These compactors are generally of a design which allows them to be used to bend, break up and compact a variety of waste, including household garbage along with yard waste. For example, U.S. Pat. No. 5,862,748, issued Jan. 26, 1999 and U.S. Pat. No. 5,857,408 to Witter, issued Jan. 12, 1999 disclose compactors which are designed to break up, crush, and compact waste. Each of these patents discloses a compactor having a heavy compacting head, such as metal, attached to a handle. The heavy weight is required to achieve the device's compacting ability. However, the weight of these compactors is disadvantageous as it is difficult for users to repeatedly lift and lower the compactor. Also, the heavy weight of the prior art compactors impedes the ability to leave the compactor attached to the end of a garden rake on a continuous basis while the user is raking leaves.

Rather, the prior art compactors are designed to be attached to a handle, other than a rake handle, which is specifically designed and sized to accept the compactor connecting end. For example, these compactors are designed to be connected to a pre-threaded handle, or by a mechanical connection such as a screw or cotter pin. These compacting devices would replace, for example, the head of a broom on a broom handle. The connection requires time and effort and cannot be instantly attached or detached.

The advent of extensive yard waste recycling has resulted in extra costs to consumers through specialized bags they have to purchase and sometimes, the municipal fee to collect each bag. Therefore, there is a need for this tamper invention which minimizes the number of bags used, and therefore reduces the costs required to dispose of light yard waste. The tamper of the present invention is advantageous over prior art tampers as it is light weight to allow use by consumers of any age and strength, it can attached and detached quickly and easily with any rake or like garden tool, and it is inexpensive.

### SUMMARY OF THE INVENTION

This invention allows easy and convenient tamping of light yard waste into a bag for collection. The unique universal pressure fit type of connection means it can be easily attached to or detached from garden rake handles of all sizes. After using a rake to aggregate light yard waste into a pile, the user typically scoops the waste onto the rake and deposits it into the bag. Using the present invention, the user could then simply invert the rake and, holding onto the rake handle, tamp the leaves down into the bag. Since the invention is lightweight, minimal effort by the user is required. The user does not have to lean over, risking back sprain, and push into the bag as they might do if using their hands to push the leaves down, nor does the user end up with wet, dirty waste residue on their hands. By using this invention, a user can easily fill a bag with much more waste than if the tamper was not used.

For example, if the volume of waste needed to fill a bag (without tamping the contents) is represented by the letter Y, then the volume of waste needed to fill a bag once tamped using the invention can be 5 times Y, and possibly more. Thus with minimal effort, the user can reduce the cost of waste elimination while reducing the possibilities of physical strain and getting dirty inherent in the waste collection process.

Preferably, the waste tamper of the present invention is made of injection molded plastic, or similar light weight material having high strength properties. The waste tamper can be attached to a rake handle by a user, simply by grasping the rake with one hand and the waste tamper with another hand, and then inserting the end of the rake handle into the connecting end of the waste tamper. An inner hollow conical channel of the waste tamper has a diminishing diameter, so at some point the rake end cannot be inserted further. Preferably, the material of the hollow conical channel has some elasticity and flexibility, allowing the end of the rake handle to be seated slightly into the material. The material may expand slightly outwards as the invention seats into the rake handle. As the invention is used, the motion of tamping the waste down ensures that the invention is further seated into the connection.

However, even after extensive use, the invention may be removed from the rake handle by a pulling the waste tamper since the material used for the insertion tube is not so flexible as to allow excessive seating. This enables a user to quickly and easily transfer the waste tamper to rakes of different sizes and designs.

Alternatively, the waster tamper can be left on the rake while raking leaves as a backstop for the user's hand at the top of the rake handle. If the user chooses to leave the invention on the rake end in a semi-permanent or permanent manner, for storage purposes, the rake can be hung from a hook device supporting a tamping end of the waste tamper. The rake handle can be seated deeply enough into the conical insertion channel to support the static weight of the rake when hanging on the invention from a hook device.

In one aspect, the present invention is directed to a waste tamper apparatus comprising: an integrally formed conical body having a tamping end and a connecting end; the tamping end having a tamping face; and the connecting end having an opening to a conical handle insertion channel extending longitudinally through an axis of the conical body generally perpendicular to the face of the tamping end, the handle insertion channel having a greater diameter at the opening and tapering towards the tamping end so that a handle can be inserted into the opening and received in the insertion channel to be held thereon by a pressure fit.

In another aspect, the present invention is directed to a waste tamper apparatus comprising: an integrally formed cylindrical body and a tamping face; the cylindrical body having an opening to a handle insertion channel extending longitudinally through an axis of the cylindrical body generally perpendicular to the tamping face, the handle insertion channel having a first section between the opening and an intermediate point along the handle insertion channel, a diameter of the first section being constant, and the handle insertion channel having a second section between the intermediate point and the tamping face, a diameter of the second section decreasing in a direction towards the tamping face so as to taper.

In a further aspect, the present invention is directed to a waste tamper apparatus comprising: a generally rectangular tamping part; and an attachment cone; the generally rectangular tamping part having a first side with at least one protruding nipple extending therefrom and a second side having a cylindrical tube substantially centrally disposed thereon the cylindrical tube having a first diameter; the attachment cone having a conical connecting portion having, at a first end, an opening and, at a second end, a base cylindrical section of a constant second diameter being less than the first diameter; the opening leading to a conical channel extending towards the cylindrical section with a conical diameter decreasing in a direction towards the cylindrical section such that a handle can be inserted in the opening to be frictionally engaged within the conical channel; and the tamping face being attachable to the conical connector by inserting the base cylindrical portion into the cylindrical tube tubular portion of the tamping face to be held thereby in a friction-fit.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a perspective view of the waste tamper;

FIG. 2 shows a bottom view of the waste tamper of FIG. 1;

FIG. 3 shows a side view of the waste tamper of FIG. 1;

FIG. 4 shows a cross-sectional side view of the waste tamper of FIG. 1;

FIG. 5 shows two of the waste tampers shown in FIG. 1 stacked together;

FIG. 6 shows a user tamping leaves into a paper bag using the waste tamper of FIG. 1 attached to the end of a rake handle;

FIG. 7 shows a cross-sectional side view of a factory yard waste tamper as part of a rake with the rake handle inserted as part of the rake manufacturing process;

FIG. 8 shows a cross-sectional side view of a waste tamper comprising two pieces, a face and an insertion cone;

FIG. 9 shows a plan view of the tamping face of the two piece tamper of FIG. 8; and

FIG. 10 shows a plan view of the underside of the face of the two piece tamper of FIG. 8.

### DETAILED DESCRIPTION OF THE PREFERRED EMBODIMENTS

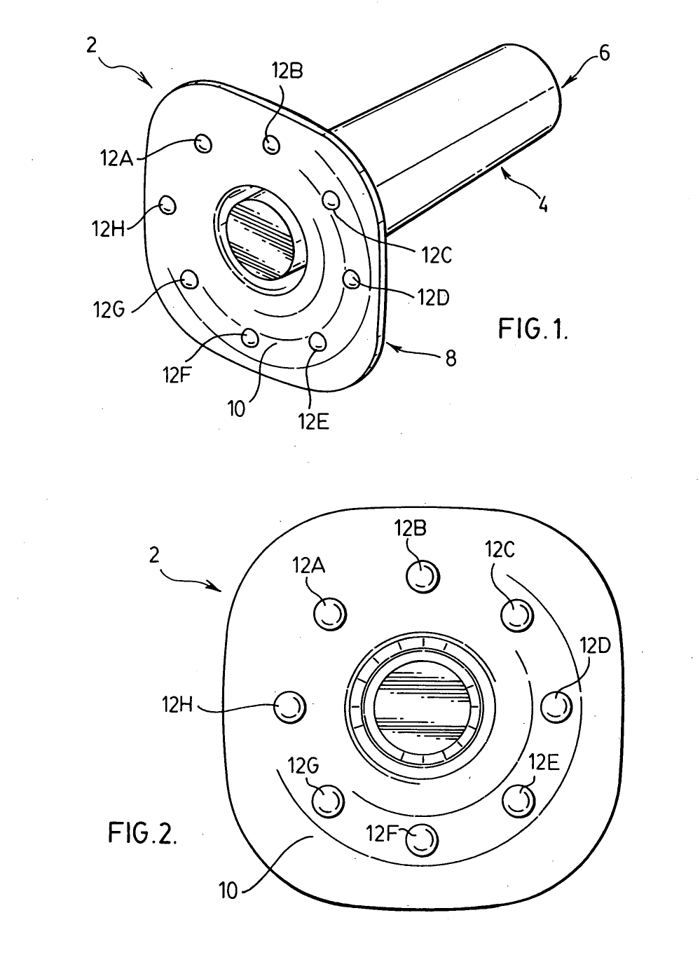

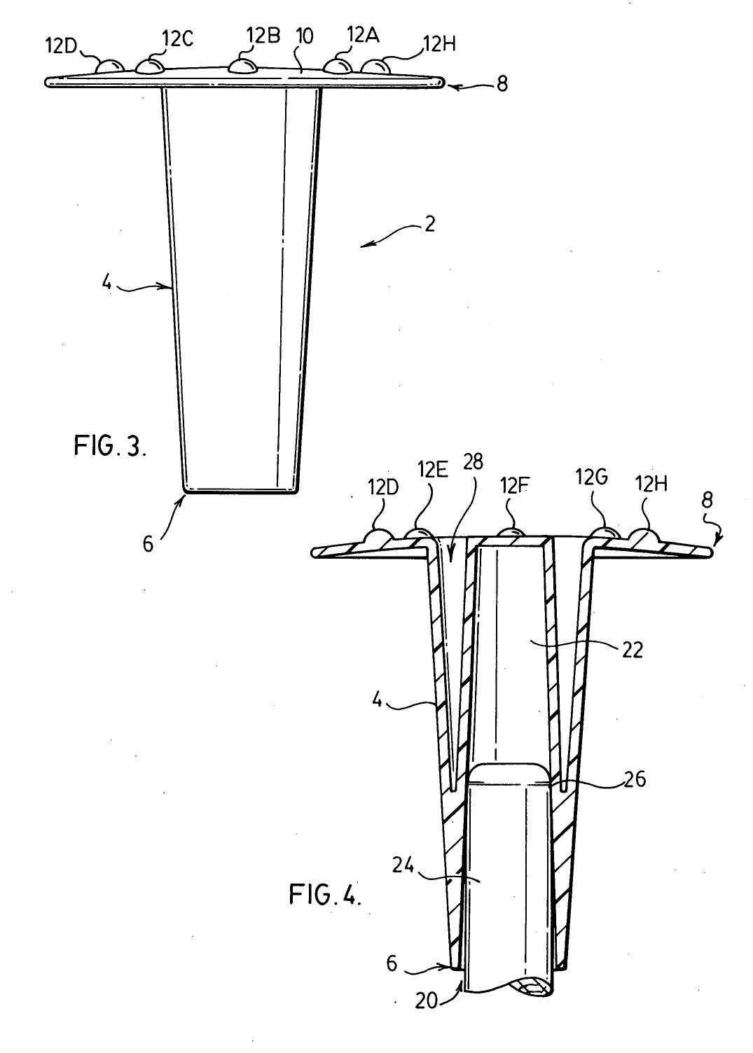

A waste tamper apparatus 2 is shown in FIGS. 1 to 4. FIG. 1 shows the tamper 2 in angled perspective side view. The tamper apparatus 2 is formed of light weight metal, such as aluminum or, preferably, from injection molded plastic. The body and walls are made as thin as possible, preferably 1.5 mm in thickness, while maintaining enough strength to perform the required functions without breaking. Preferably, the tamper apparatus weighs between 0.08 and 0.12 kg, and more preferably 0.1 kg.

The tamper apparatus 2 consists of an integrally formed conical body 4 having a connecting end 6 and an oppositely disposed tamping end 8. The connecting end 6 has an opening 20, as shown in the cross-section of FIG. 4, to accept a cylindrical handle 24 of a rake. To attach the tamper apparatus to the rake handle 24, the cylindrical rake handle 24 is inserted into the opening 20 and through a conical handle insertion channel 22 until the handle 24 contacts the channel 22 at a connection point 26. The tamper apparatus 2 is made of slightly flexible light-weight material and is held on the handle 24 by friction fit at the contacting circumference 26.

Depending on the ratio of the diameter of the rake handle 24 and the diameter of the conical handle insertion channel 22, a space is provided between the contacting circumference 26 and an inside of the insertion end of the channel. However, the waste tamper apparatus 2 does not rock, when in use, even if the space is noticeable, because the inner surface area of the channel 22 is sufficiently close to the rake handle 24 at the contacting circumference 26, as shown in FIG. 4. Also, because the handle 24 is cylindrical and is fitted into the insertion channel 22, which is conical, the waste tamper apparatus 2 is self-centered on the handle 24 which obviates any possibility of rocking.

As shown in FIG. 2, the tamping end 8 has a substantially rectangular tamping face 10 having rounded corners and a slightly turned up edge. The tamping face 10 is slightly convex and the shape of the tamping face 10 enables the tamper apparatus to work well with either square or rounded bags and will not cut into the bag, in particular because of the rounded corners. Preferably, the tamping face has an area between 150 cm² and 350 cm², and more preferably between 200 cm² and 300 cm². The tamping face 10 also has nipples 12A, 12B, 12C, 12D, 12E, 12G and 12H protruding therefrom. The nipples 12A, 12B, 12C, 12D, 12E, 12F, 12G and 12H are rounded bumps which are helpful in packing leaves and also preventing wet leaves from sticking to the tamping face 10.

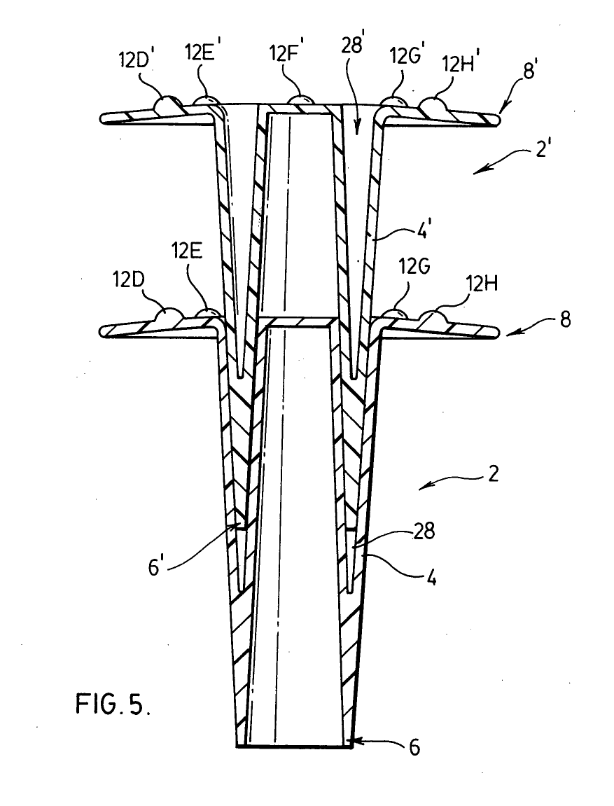

As can be seen in FIG. 4, the tamping face 10 has an annular opening 28 which opens into an annular space which extends from the tamping face 10 towards the connecting end 6. The purpose of providing the annular opening 28 is so that multiple tamper apparatuses can be “stacked” for more efficient shipping and retailing. As shown in FIG. 5, the connecting end 6′ of one tamper apparatus 2′ is fitted into the annular opening 28 of another tamper apparatus 2 so that the two tamper apparatuses 2 and 2′ nest with one another in a stacking manner.

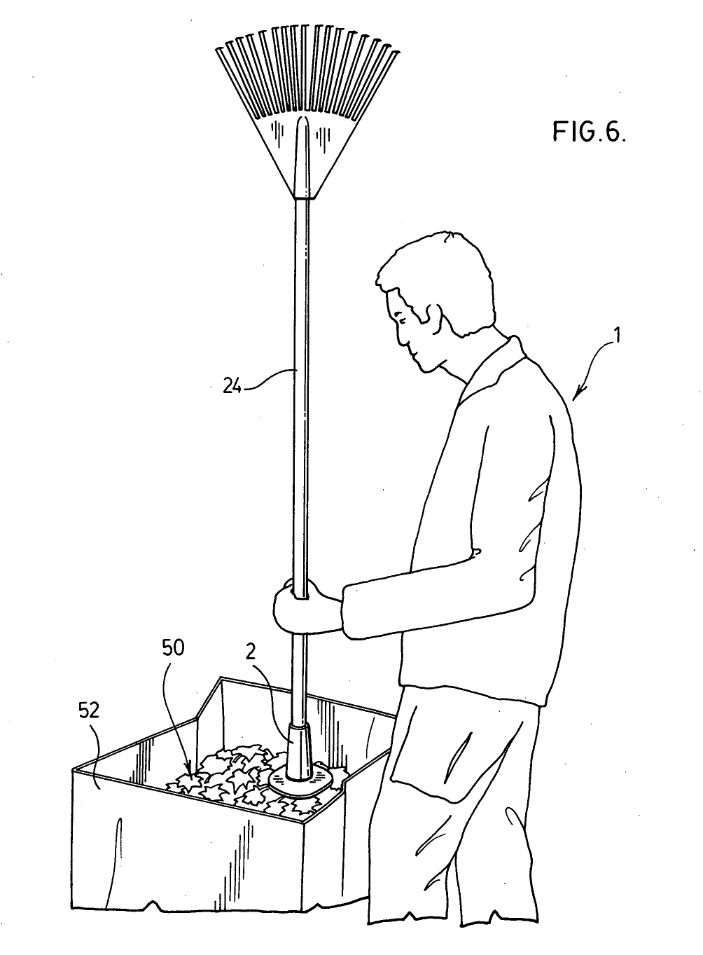

FIG. 6 shows the tamper apparatus 2 in use. The tamper apparatus 2 is attached to the end of the rake handle 24 and a user 1 manipulates the rake handle 24 to compact leaves 50 in a paper bag 52.

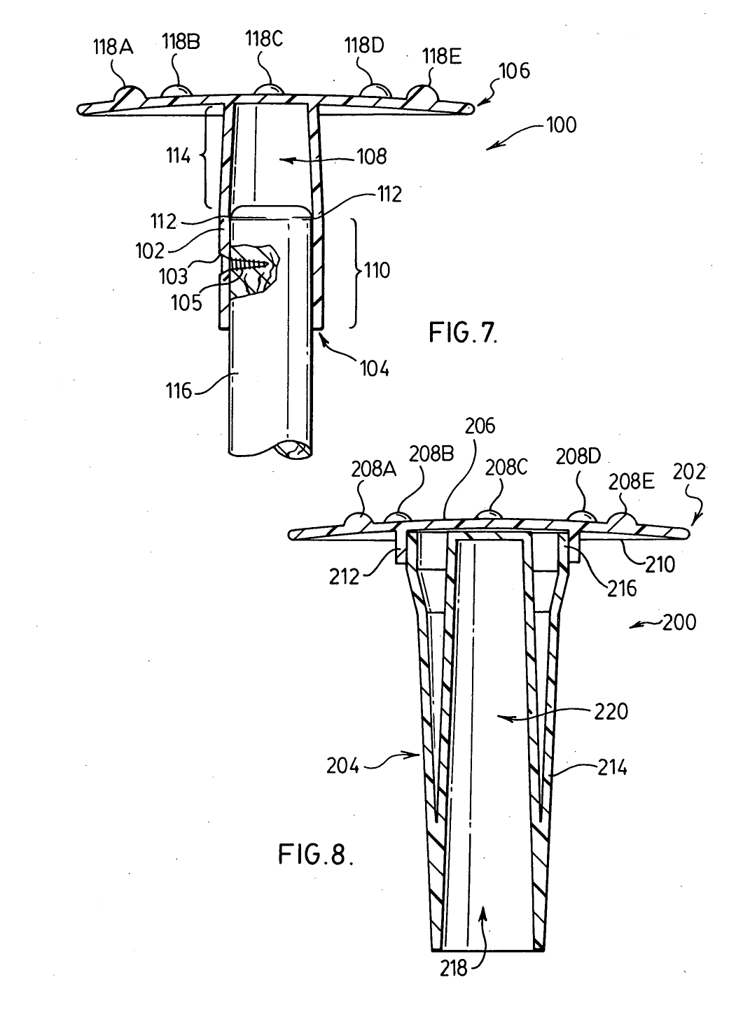

FIG. 7 shows an alternate embodiment of the present invention whereby a waste tamper apparatus 100 has an integrally formed cylindrical body 102 and a tamping face 106 perpendicularly disposed to the handle 102.

The cylindrical body 102 has an opening 104 to a cylindrical handle insertion channel 108. In this embodiment, the tamper apparatus 100 is constructed to be applied to an end of a rake handle when the rake is manufactured. In this case, the diameter of the rake handle is known, and an inner diameter of the cylinder body opening 104 is custom sized to specifically fit a diameter of a rake handle 116.

The cylindrical body 102 has a constant diameter in a first section which extends from the opening 104 to an intermediate point 112. A second section 114 has a diameter which decreases from the intermediate point 112 to the tamping face 106 so as to taper. The rake handle 116 can be inserted into the channel 108 to the intermediate point 112, where the end of the rake handle 116 abuts the inner diameter of the cylindrical body 102. The tamper apparatus 100 is held on the rake handle 116 by friction fit.

Also, the depth of insertion of the end of the rake handle can be increased or reduced by altering the position of the intermediate point 112 so that more or less of the rake handle is fitted in the cylindrical channel 108. By inserting a longer portion of the end of the rake handle 116 into the cylindrical channel 108, increased stability can be provided.

Also shown in FIG. 7, nipples 118A, 118B, 118C, 118D and 118E are provided on the tamping face 106. The nipples 118A, 118B, 118C, 118D and 118E are rounded protrusions which are helpful in packing leaves and also preventing wet leaves from sticking to the tamping face 106.

The embodiment shown in FIG. 7 is advantageous as there is no visible gap between aside of the rake handle 116 and the untapered cylindrical first section 110. Also, because of the close tolerance between the untapered cylindrical first section 110 and the rake handle 116, any rocking motion of the tamper apparatus 100 on the handle 116 during use is eliminated. Furthermore, the tamper apparatus 100 can be permanently fixed to the end of the rake handle 116, for example, by an adhesive added inside the cylindrical first section 110 when a manufacturer inserts the end of the rake handle 104.

Alternatively, the tamper apparatus 100 can be permanently fixed to the end of the rake handle 116 by a screw or other similar mechanical fastener. As shown in FIG. 7, the tamper apparatus 100 has a small dimple 103 moulded or drilled into the outside of the sleeve 102 to act as a guide to accept a screw 105. Preferably, the screw 105 is 2.5 cm long and coarsely threaded. Once the tamper apparatus 100 is positioned at a desired positioned on the rake handle 116, the screw 105 is screwed through the dimple 103 and into the rake handle 116 to fix the tamper apparatus 100 to the rake handle 116.

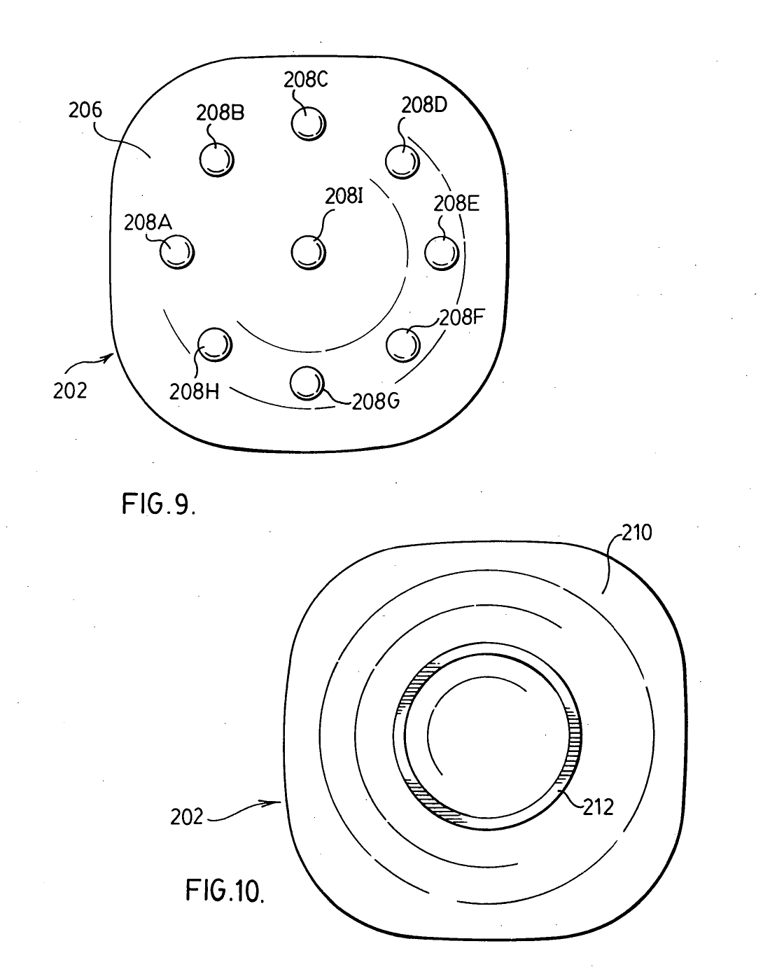

FIG. 8 shows a two piece tamper apparatus 200. The two piece tamper apparatus 200 has a generally rectangular tamping part 202 shown in FIGS. 9 and 10, and an attachment cone 204. The generally rectangular tamping part 202 has a first side 206, shown in FIG. 9 with nipples 208A, 208B, 208C, 208D, 208E, 208F, 208G, 208H and 208I projecting therefrom. The tamping part 202 has a second side 210, shown in FIG. 10, with a cylindrical tube 212 centrally disposed on the second side 210 of the tamping face 202. The cylindrical tube 212, preferably between 2 cm and 5 cm deep, is positioned with a central axis substantially perpendicular to a plane of the tamping face 202.

The attachment cone 204 has a conical connecting portion 214 having a diameter which increases towards a base cylindrical portion 216 which has a constant diameter. An outer diameter of the base cylindrical portion is slightly less than an inner diameter of the cylindrical tube 212. The tamping face 202 is attached to the attachment cone by inserting the base cylindrical portion 216 into the cylindrical tube 212 of the tamping face to be held thereby in a friction-fit. Alternatively, the base cylindrical portion 216 can be held within the cylindrical tube 212 using adhesive such as glue.

The attachment cone 204 has an opening 218 leading a conical channel 220 extending from the opening 218 towards the cylindrical section 216. The conical channel 220 has a diameter which decreases in a direction towards the cylindrical section 216 such that a handle (not shown) can be inserted in the opening 218 to be frictionally engaged with the inner walls of the conical channel 220.

The two piece tamper apparatus 200 facilitates cheap shipping costs since the tamping face 202 and attachment cone 204 can be easily contained in an envelope for shipping whereas the one piece design would have to be shipped in a box. However, the two piece tamper apparatus 200 also obtains the benefits of light weight, portability, and ease of use as the previously described tamper apparatus designs.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

Also, it will be understood that, although various features of the invention have been described with respect to one or another of the embodiments of the invention, the various features and embodiments of the invention may be combined or used in conjunction with other features and embodiments of the invention as described and illustrated herein.

What is claimed is:

1. A waste tamper apparatus comprising:
an integrally formed conical body having a tamping end and a connecting end;
the tamping end having a tamping face; and
the connecting end having an opening to a conical handle insertion channel extending longitudinally through an axis of the conical body generally perpendicular to the face of the tamping end, the handle insertion channel having a greater diameter at the opening and tapering towards the tamping end so that a handle can be inserted into the opening and received in the insertion channel to be held thereon by a pressure fit.

2. The waste tamper of claim 1, wherein an annular opening is provided at the tamping face and forms an annular space extending towards the connecting end wherein a second waste tamper can be stacked with the waste tamper by inserting a respective connecting end of the second waste tamper into the annular opening of the waste tamper.

3. The waste tamper apparatus of claim 1, wherein the tamping face has a generally convex shape.

4. The waste tamper apparatus of claim 1, wherein the tamping face has at least one nipple protruding therefrom.

5. The waste tamper apparatus of claim 1, wherein the tamping face has a plurality of nipples protruding therefrom in an annular orientation, each of the nipples being spaced substantially equidistant from an adjacent one of the nipples.

6. The waste tamper apparatus of claim 1, wherein the integrally formed conical body comprises lightweight material.

7. The waste tamper apparatus of claim 1, wherein the integrally formed conical body comprises plastic.

8. The waste tamper apparatus of claim 1, wherein the integrally formed conical body comprises injection molded light weight material.

9. The waste tamper apparatus of claim 1, wherein the integrally formed conical body comprises injection molded plastic.

10. A waste tamper apparatus comprising:
an integrally formed cylindrical body and a tamping face;
the cylindrical body having an opening to a handle insertion channel extending longitudinally through an axis of the cylindrical body generally perpendicular to the tamping face, the handle insertion channel having a first section between the opening and an intermediate point along the handle insertion channel, a diameter of the first section being constant, and the handle insertion channel having a second section between the intermediate point and the tamping face, a diameter of the second section decreasing in a direction towards the tamping face so as to taper.

11. The waste tamper apparatus of claim 10, wherein the tamping face has a generally convex shape.

12. The waste tamper apparatus of claim 11, wherein the generally convex tamping face has at least one nipple protruding therefrom.

13. The waste tamper apparatus of claim 11, wherein the generally convex tamping face has a plurality of nipples protruding therefrom in an annular orientation, each of the nipples being spaced substantially equidistant from an adjacent one of the nipples.

14. The waste tamper apparatus of claim 10, wherein the integrally formed cylindrical body and tamping face comprise lightweight material.

15. The waste tamper apparatus of claim 10, wherein the integrally formed cylindrical body and tamping face comprise plastic.

16. The waste tamper apparatus of claim 10, wherein the integrally formed cylindrical body and tamping face comprise injection molded light weight material.

17. The waste tamper apparatus of claim 10, wherein the integrally formed cylindrical body and tamping face comprise injection molded plastic.

18. The waste tamper apparatus of claim 10, wherein the cylindrical body is fixed to a handle using a mechanical fastener.

19. The waste tamper apparatus of claim 10, wherein the cylindrical body has a dimple formed at a position in the first section, the dimple being sized to accept a screw to fix the cylindrical body to a handle.

20. A waste tamper apparatus comprising:
a generally rectangular tamping part; and
an attachment cone;
the generally rectangular tamping part having a first side with at least one protruding nipple extending therefrom and a second side having a cylindrical tube substantially centrally disposed thereon the cylindrical tube having a first diameter;
the attachment cone having a conical connecting portion having, at a first end, an opening and, at a second end, a base cylindrical section of a constant second diameter being less than the first diameter;
the opening leading to a conical channel extending towards the cylindrical section with a conical diameter decreasing in a direction towards the cylindrical section such that a handle can be inserted in the opening to be frictionally engaged within the conical channel; and
the tamping face being attachable to the conical connector by inserting the base cylindrical portion into the cylindrical tube tubular portion of the tamping face to be held thereby in a friction-fit.

21. The waste tamper apparatus of claim 20, wherein the cylindrical section is held within the tubular portion by adhesive.

22. The waste tamper apparatus of claim 20, wherein the cylindrical section is held within the tubular portion by a mechanical fastener.
